(19) United States
(12) Patent Application Publication
(10) Pub. No.: US 2025/0145218 A1
(43) Pub. Date: May 8, 2025

(54) SUBFRAME FOR A MOTOR VEHICLE

(71) Applicant: BENTELER AUTOMOBILTECHNIK GMBH, Paderborn (DE)

(72) Inventors: Julian ALTEMEIER, Paderborn (DE); Tomas SVOBODA, Liberec (CZ)

(21) Appl. No.: 18/932,624

(22) Filed: Oct. 31, 2024

(30) Foreign Application Priority Data
Nov. 3, 2023 (EP) 23207733.9

(51) Int. Cl. B62D 21/02; B62D 27/02

(52) U.S. Cl. CPC B62D 21/02; B62D 27/02

(57) ABSTRACT

A subframe for a motor vehicle has a frame body made of shell components and at least one mounting sleeve. Each mounting sleeve has a sleeve body with a longitudinal passage and a sleeve head with a passage opening. According to the present disclosure, the sleeve head is a cold extruded part, wherein the passage opening in the sleeve head is produced in the sleeve head during cold extrusion. The sleeve head is positioned on the front side on the sleeve body.

### RELATED APPLICATIONS

The present application claims priority of European Application Number 23207733.9 filed Nov. 3, 2023, the disclosure of which is hereby incorporated by reference herein in its entirety.

### FIELD

The present disclosure relates to a subframe for a motor vehicle, which has a frame body and at least one mounting sleeve, wherein the mounting sleeve has a sleeve body with a longitudinal passage and a sleeve head with a passage opening.

### BACKGROUND

Subframes for motor vehicles, which are also referred to as axle supports, unit carriers or bogies, are bolted to the body via connection points. The subframe has a frame body that forms a rectangle or trapezoid that is open on the inside, wherein the frame body is welded from two or more sheet metal form parts to form a hollow profile. The body-side articulation points of the wheel suspensions are attached to the subframe. If the subframe is to take on additional functions, the frame body has additional structural or add-on components. The subframe is able to be rigidly bolted to the body or connected to the body via elastic bearings.

EP 2 902 303 B1 describes a subframe for a motor vehicle which has two shell elements connected to each other and at least one body connection sleeve for inserting a screw. The body connection sleeve is a mounting sleeve that has a sleeve body with a disc-like sleeve head.

A fastening system for connecting an axle frame to a body of a motor vehicle is described in to DE 10 2015 208 898 B3. The fastening system includes a mounting sleeve which is able to be fixed on or in the frame body and connects two spaced-apart wall portions of the frame body.

DE 10 2016 121 756 B3 describes a two-part body connection sleeve including a spacer sleeve and a separate body connection sleeve.

CN 217598682 U describes a subframe for a motor vehicle, which has a frame body and mounting sleeves. The mounting sleeves are designed as a single piece with a sleeve body and a sleeve head. The column structure of the mounting sleeve is to be formed by cold heading technology.

### SUMMARY

The object of the present disclosure is to provide a subframe for a motor vehicle with improved connection or articulation points and mounting sleeves with improved manufacturing and component technology.

The subframe according to the present disclosure has a frame body and at least one mounting sleeve. The frame body is made of shell components. The shell components are made of sheet metal and are assembled to form the frame body. The frame body has a cavity portion with two spaced-apart walls. The mounting sleeve extends between two openings positioned in the walls of the frame body, which are coaxially opposite each other and have a common central longitudinal axis.

A mounting sleeve has a sleeve body with a longitudinal passage and a sleeve head with a passage opening. These are separate components that are assembled to form the mounting sleeve. The passage opening in the sleeve head is a continuation of the longitudinal passage in the sleeve body. The sleeve body and the sleeve head have a common central longitudinal axis.

The sleeve head and the sleeve body are manufactured separately and put together to form the mounting sleeve, with the sleeve head positioned on the front side of the sleeve body. The sleeve head rests on the front side of the sleeve body.

The sleeve head is a cold-extruded part, wherein the passage opening in the sleeve head is created during cold extrusion in the sleeve head. The sleeve head, which is manufactured separately by cold extrusion, is positioned on the front side on one end of the sleeve body.

The mounting sleeves according to the present disclosure provide a subframe for a motor vehicle to be advantageously designed with regard to its connection or articulation points and to be integrated into the chassis system of motor vehicles. to the subframe is able to be efficiently adapted to different series of motor vehicles by corresponding design the mounting sleeves. The mounting sleeves are provide sleeve bodies with complex shapes and materials, with sleeve heads adapted to the application.

The mounting sleeves extend between two walls of the frame body and the openings arranged in the walls. The mounting sleeves are able to be fixed in the openings. The mounting sleeves with the sleeve bodies are also able to contact an inner surface of a wall of the frame body and surround an opening in the wall of the frame body. In the contact region with the wall, the mounting sleeves and the frame body are joined together in a material manner.

The sleeve heads are manufactured by cold extrusion, i.e. cold forging. In general, cold forging is also understood to mean cold extrusion. The forming process takes place at room temperature. The forming tool does not undergo any active heating and the temperature of the material remains below the recrystallization temperature. During the cold flow process, a solid blank is subjected to such high pressure that the material begins to flow. The sleeve head obtains its outer contour through cold extrusion. During cold extrusion, the through hole is created in the sleeve head. The production of the sleeve heads or the forming of the sleeve heads themselves are able to be carried out in one or more process steps. After the cold flow process, the sleeve head is able to have its final geometry. Depending on the design of the sleeve heads, only minimal post-processing of the sleeve heads is required after cold extrusion.

The sleeve heads have a passage opening extending in the longitudinal direction of the mounting sleeve, which communicates with the longitudinal passage in a sleeve body.

The sleeve bodies are able to have different wall thicknesses, depending on the strength or load requirements.

The mounting sleeve is able to have a sleeve body with a longitudinal slot.

In at least one embodiment of the present disclosure, the mounting sleeve has a sleeve body with a longitudinal slot and a cold extruded sleeve head which is integrally materially joined to the sleeve body on the front side.

The sleeve body is able to be seamless.

The sleeve body is able to be a longitudinally welded pipe piece.

The sleeve body is able to be an extruded pipe piece.

The sleeve head and the sleeve body are able to be joined together in a form-fitting and/or force-fitting and/or material-fitting manner.

Depending on the design, the sleeve head is able to be placed on the sleeve body. The two components are fixed to each other by means of a mounting screw that is guided through the mounting sleeve in the frame body of the subframe.

The sleeve head and the sleeve body are able to be mechanically connected by a press connection or press joining.

An alternative aspect provides that the sleeve head and the sleeve body are form-fittingly connected to each other. In this case the joining surfaces of the sleeve body and sleeve head are geometrically matched in such a way that a positive connection is achieved by interlocking at least one respective form-fitting element on the sleeve head and on one end of the sleeve body.

In at least one embodiment of the present disclosure, the sleeve bodies are roll-formed, rolled or produced by U-O forming.

The sleeve body is able to be manufactured by roll forming. The starting material can be a flat metal band made of steel or high-strength stainless steel. A long profile is able to be produced in the form of a slotted tube, from which the sleeve bodies are cut to the required length. Of course, a single prefabricated sheet metal plate is able to be formed into a sleeve body.

The sleeve body is able to be manufactured by U-O forming of a sheet metal plate. The sheet metal plate is prefabricated and corresponds to the unwound sleeve body. U-O forming is also able to be used to produce long profiles in the form of slotted tubes, from which the sleeve bodies are cut to the required length.

The sleeve head is positioned and joined to one front side of the sleeve body.

The sleeve body is able to have a longitudinal slot, which is straight or bent or curved. A straight longitudinal slot is also able to be inclined to the central longitudinal axis.

The sleeve body has longitudinal edges opposite each other along the longitudinal slot. These are able to be spaced apart from each other or lie next to each other without a gap.

A butt joint is formed between the longitudinal edges.

Form-fitting elements are able to be formed on the longitudinal edges of the sleeve body extending along the longitudinal gap. These are designed to be complementary to each other and interlock with each other. The longitudinal edges are able to be interlocked.

The longitudinal edges of the sleeve body are able to be joined together completely or at least partially. The longitudinal edges along the longitudinal slot of the sleeve body are able to be joined by welding.

The sleeve head is able to be geometry tailored to its connection function. Complex sleeve head form geometries are possible. The sleeve head is able to be reworked after its cold-press production. The sleeve head is also able to be heat treated.

In at least one embodiment of the present disclosure, the sleeve bodies with complex shapes are able to be produced for fastening parts to the subframe or for fastening the subframe. In at least one embodiment of the present disclosure, sleeve bodies are able to be provided in the required length, tailored to the intended use or assembly.

In at least one embodiment of the present disclosure, the sleeve head has a disc element resting on the front side of the sleeve body and at least one positioning element on the sleeve body side which projects into the sleeve body. This is advantageous both for joining the sleeve head and sleeve body and for the stability of the mounting sleeve.

Furthermore, the sleeve head is able to have at least one positioning element on the sleeve body side, i.e., on the side facing the sleeve body, which rests on the outside of the front end portion of the sleeve body. In at least one embodiment of the present disclosure, the sleeve body-side positioning element partially or totally surrounds the end portion of the sleeve body on the outside.

In at least one embodiment of the present disclosure, the sleeve head has a mounting portion on its side facing away from the sleeve body. The mounting portion is able to be provided on an outer surface of the sleeve head. The mounting portion is also able to be formed on the inside of the sleeve head, for example, at a central passage opening of the sleeve head. The mounting portion is able to, for example, be an internal thread portion in the sleeve head.

Mounting sleeves of different designs are used in the subframe according to the present disclosure. The mounting sleeves are ale to differ in the shape and geometry of the sleeve head, the length of the sleeve body and the position of the sleeve head relative to the frame body of the subframe. The sleeve head is able to be positioned opposite an outer surface of the frame body. The sleeve head is able to rest on a wall above an opening in a wall of the frame body, and the sleeve head is also able to rest on the inside against a wall of the frame body. Furthermore, a sleeve body is able to protrude on one or both sides from a wall of the frame body or rest on the inside against a wall of a frame body.

The sleeve body of a mounting sleeve is able to protrude through an opening in a wall of the frame body, wherein the sleeve head of the mounting sleeve is arranged at a distance from an outer surface of the frame body. The sleeve body has a length that is greater than the distance between the walls of the frame body in the cavity portion in which the mounting sleeve is arranged between the openings in the walls. The mounting sleeve protrudes from the frame body with a longitudinal portion on the sleeve head side.

Such mounting sleeves are used for connecting elastic bearing components, for example, as body-side articulation points of the wheel suspension. The mounting sleeves are part of the body connection of the subframe and of the fastening system for connecting the subframe to the body of a motor vehicle.

The fastening system is able to be adapted to different series of bodies depending on the length of the mounting sleeve and the distance between the frame body and the sleeve head, i.e., the longitudinal portion of the mounting sleeve protruding from the frame body.

Furthermore, mounting sleeves are able to have a sleeve head which is arranged in an opening in a wall of the frame body. The sleeve head is able to be flush with the outer surface of the frame body or its front side is able to protrude slightly beyond the outer surface of the wall of the frame body.

In a further embodiment of a mounting sleeve, the sleeve head is able to rest against the frame body with a contact surface on the sleeve body side.

The sleeve body is able to protrude through an opening in a wall of the frame body with an end portion remote from the sleeve head. This helps increase the stability of the connection, the accessibility of the mounting sleeves and expands the range of applications of the mounting sleeves and function in the subframe.

In at least one embodiment of the present disclosure, the sleeve body contacts an inner surface of a wall of the frame body with an end facing away from the sleeve head and thereby surrounds an opening in the wall of the frame body.

The opening in the wall of the frame body is able to be provided in a cup-shaped recess. On the inside, the sleeve body rests with its end on the inner surface of the wall that surrounds the opening and is joined to the frame body.

In addition to the mounting sleeves according to the present disclosure, further support sleeves are able to be arranged in the interior of the frame body or in hollow portions of the frame body, which extend between two opposite, coaxially arranged openings in the walls of the frame body.

A sleeve head is able to have a friction structure. The friction structure increases the friction on the sleeve body in the region around the passage opening.

A friction structure is also able to be provided on the back or on the side of the sleeve head facing the sleeve body.

In at least one embodiment of the present disclosure, the friction structure is provided on the front side of the sleeve head. The friction structure increases the friction on the front side of the sleeve head and efficiently transfers the force exerted by a screw element to the surface in the region of the friction structure. In this way, screw elements are held better and the connection is able to transmit higher transverse forces.

In at least one embodiment of the present disclosure, the friction structure at least partially surrounds the passage opening in the sleeve body.

The friction structure is created during the cold extrusion process for the production of the sleeve head. If necessary, the three-dimensional geometry of the friction structure is finished by subsequent processing.

The friction structure is able to be formed by one or more friction elements which run as a ring or crown around the passage opening. Furthermore, the friction structure is able to be composed of friction elements in the form of ribs or points.

In at least one embodiment of the present disclosure, the friction structure is formed by laser dimplings or contains laser dimplings. In at least one embodiment of the present disclosure, the cold-formed sleeve head is provided with laser dimplings.

In at least one embodiment of the present disclosure, the sleeve head and the sleeve body have different materials. The materials and respective material properties are tailored to the use within the subframe and the connection points to be realized with the mounting sleeves.

A further embodiment provides that the sleeve body and/or the sleeve head are hardened and/or tempered.

In at least one embodiment of the present disclosure, the hardness of a sleeve head is able to be increased by a hardening process. Through a combined heat treatment during tempering, the sleeve body and the sleeve head are able to have a higher strength and at the same time high toughness. During tempering, the components are hardened, quenched and then annealed. During tempering, the hardness is increased while at the same time a high level of toughness is achieved.

### BRIEF DESCRIPTION OF THE DRAWINGS

The present disclosure is described in more detail hereinafter with reference to exemplary embodiments illustrated in the drawings. In the figures:

FIG. 1 shows a subframe according to the present disclosure in a perspective view;

FIG. 2 shows a section through the subframe as shown in FIG. 1 according to an embodiment of the present disclosure;

FIG. 3 shows a section through the frame body of the subframe in the region of a mounting sleeve of the first type according to an embodiment of the present disclosure;

FIG. 4 shows a further sectional view through the subframe according to the representation of FIG. 1 according to an embodiment of the present disclosure;

FIG. 5 shows a section through the frame body of the auxiliary support in the region of a mounting sleeve of the second type according to an embodiment of the present disclosure;

FIG. 6 shows a mounting sleeve in a perspective view according to an embodiment of the present disclosure;

FIG. 7 shows a vertical longitudinal section through the mounting sleeve according to FIG. 6 according to an embodiment of the present disclosure;

FIG. 8 shows a mounting sleeve mounted in a frame body of a subframe according to an embodiment of the present disclosure;

FIG. 9 shows another embodiment of a mounting sleeve in a vertical longitudinal section according to the present disclosure;

FIG. 10 shows a cross-sectional view through a further embodiment of a subframe with a sectional view in the region of a mounting sleeve according to the present disclosure;

FIG. 11A and FIG. 11B show different embodiments of sleeve heads in two perspective views each according to the present disclosure;

FIG. 12A and FIG. 12B show different embodiments of sleeve heads in two perspective views each according to the present disclosure;

FIG. 13A and FIG. 13B show different embodiments of sleeve heads in two perspective views each according to the present disclosure;

FIG. 14A and FIG. 14B show different embodiments of sleeve heads in two perspective views each according to the present disclosure;

FIG. 15A and FIG. 15B show different embodiments of sleeve heads in two perspective views each according to the present disclosure;

FIG. 16A and FIG. 16B show different embodiments of sleeve heads in two perspective views each according to the present disclosure;

FIG. 17A and FIG. 17B show different embodiments of sleeve heads in two perspective views each according to the present disclosure;

FIG. 18A and FIG. 18B show different embodiments of sleeve heads in two perspective views each according to the present disclosure;

FIG. 19A and FIG. 19B show different embodiments of sleeve heads in two perspective views each according to the present disclosure;

FIG. 20A and FIG. 20B show different embodiments of sleeve heads in two perspective views each according to the present disclosure;

FIG. 21A and FIG. 21B show different embodiments of sleeve heads in two perspective views each according to the present disclosure;

FIG. 22A and FIG. 22B show different embodiments of sleeve heads in two perspective views each according to the present disclosure;

FIG. 23A and FIG. 23B show different embodiments of sleeve heads in two perspective views each according to the present disclosure; and

FIG. 24A and FIG. 24B show different embodiments of sleeve heads in two perspective views each according to the present disclosure.

### DETAILED DESCRIPTION

In the figures, the same reference numerals are used for identical or functionally corresponding components or component parts, although a repeated description is omitted for reasons of simplicity.

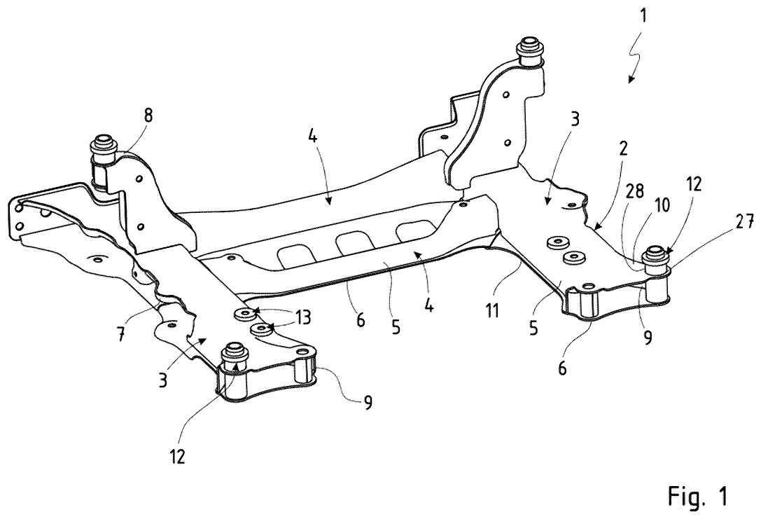

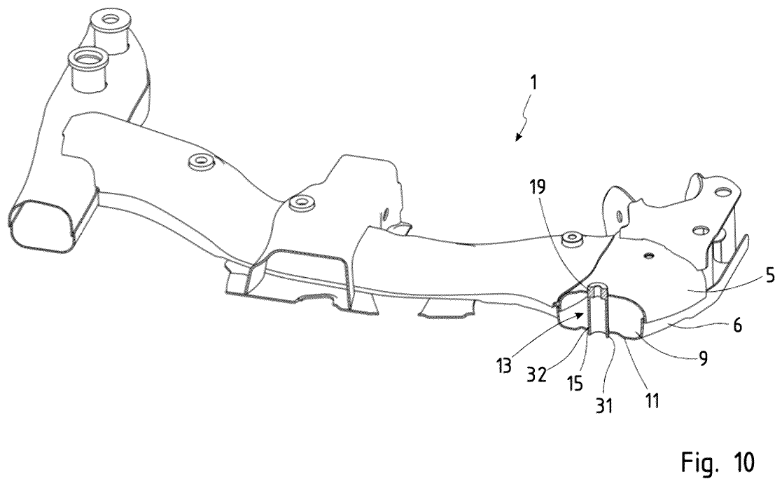

FIG. 1 shows a subframe 1 for a motor vehicle in a perspective view. FIG. 10 shows a detail of a subframe 1 of a further embodiment.

The subframe 1 has a frame body 2 which includes frame profiles 3, 4. The frame profiles 3, 4 are longitudinal member profiles and cross member profiles. The frame body 2 has in its basic form the shape of a rectangle that is open on the inside.

The frame profiles 3, 4 are formed from shell components 5, 6 made of sheet metal. Furthermore, add-on components 7 and structural components 8 for mounting different chassis or drive components of the motor vehicle are fixed to the frame body 2.

The frame body 2 of a subframe 1 are able to be designed as a hollow profile overall, for example, the frame profiles 3, 4, i.e., the longitudinal members and the cross members, are designed as hollow profiles. The frame profiles 3, 4 have a cavity portion 9 with two spaced-apart walls 10, 11. Mounting sleeves 12, 13 are provided for connecting the subframe to a body and for linking chassis or drive components of the motor vehicle. The mounting sleeves 12, 13 extend between two openings 14, 15 arranged in the walls 10, 11 of the frame body 2. The openings 14, 15 are coaxially opposite one another and have a common central longitudinal axis.

Mounting sleeves 12 of the first type and mounting sleeves 13 of the second type are installed in the subframe 1.

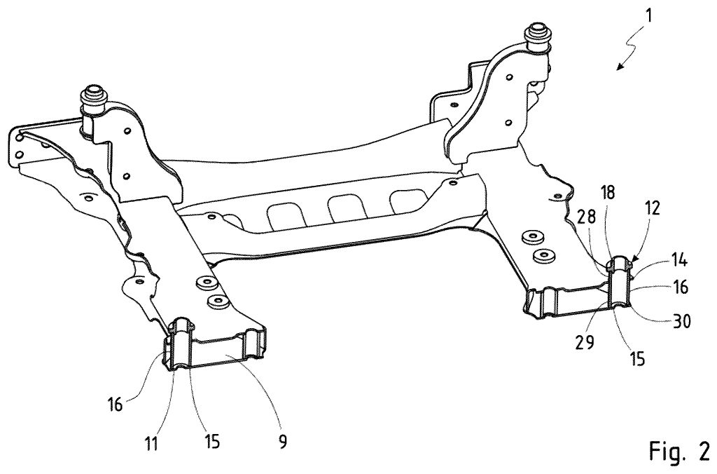

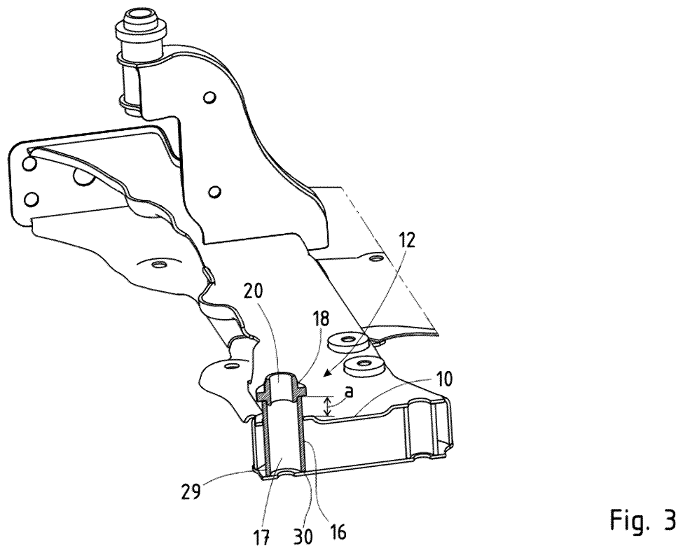

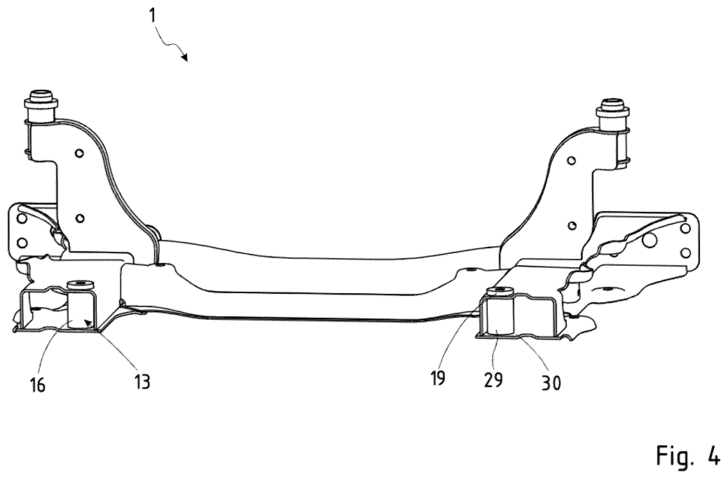

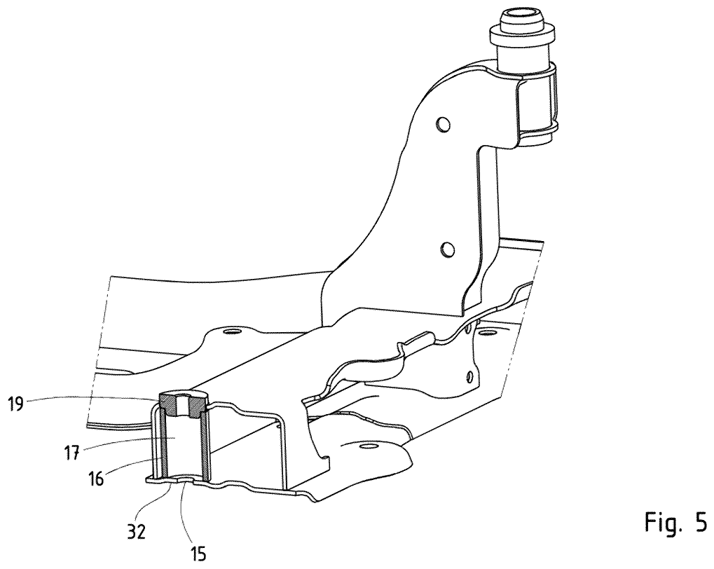

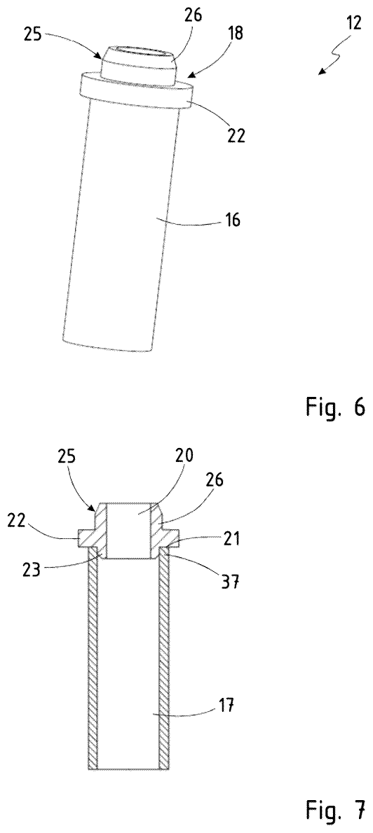

Mounting sleeves 12 of the first type are able to be seen in FIG. 2 and FIG. 3 as well as FIG. 6 to FIG. 8. Mounting sleeves 13 of the second type are shown in FIG. 4, FIG. 5, FIG. 9 and FIG. 10.

The mounting sleeves 12, 13 have a sleeve body 16 and a cold extruded sleeve head 18, 19. Each sleeve head 18, 19 has a passage opening 20. The passage opening 20 is created during cold extrusion of the sleeve head 18, 19. The cold extruded sleeve heads 18, 19 are positioned on an front side 21 of the sleeve body 16.

The sleeve bodies 16 and the sleeve heads 18,19 are separately manufactured components which are assembled to form the mounting sleeve 12, 13. A sleeve head 18, 19 is able to be joined to the sleeve body 16 in a form-fitting and/or cold-fitting manner.

In a form-fitting connection, the joining surfaces of sleeve body 16 and sleeve body 18,19 are geometrically matched to one another, so that a form-fit is achieved by interlocking at least one respective form-fitting element on the sleeve head 18,19 and on a front end of a sleeve body 16.

A force-fitting connection is able to be achieved by a press connection or press-fitting of the sleeve head 18,19 and the sleeve body 16.

The sleeve bodies 16 and the sleeve heads 18, 19 are able to include different materials, for example, steel materials.

The mounting sleeves 12 of the first type and the mounting sleeves 13 of the second type differ in the design of the sleeve heads 18 and 19, respectively, or in the position of the sleeve head 18, 19 relative to the outer surface of a wall 10, 11 of the frame body 2.

A sleeve head 18, 19 has a disc element 22 which rests on the sleeve body 16 at the front side and a positioning element 23 on the sleeve body side which projects into the sleeve body 16. This is possible both for the sleeve heads 18 of the mounting sleeves 12 of the first type and for the sleeve heads 19 of the mounting sleeves 13.

On the front side 24 facing away from the sleeve body 16, the sleeve heads 18 have a mounting portion 25.

In the sleeve heads 18 of the mounting sleeves 12 of the first type, the mounting portions 25 are designed as a recess 26 protruding from the disc element 22 with rounded outer surfaces. The mounting portion 25 of the sleeve heads 18 of the mounting sleeves 12 of the first type is dome-shaped.

Both the sleeve heads 18 of the mounting sleeves 12 of the first type and the sleeve heads 19 of the mounting sleeves 13 of the second type have a central passage opening 20. Mounting portions in the form of internal threads are able to be provided in the passage openings 20.

The sleeve bodies 16 of the mounting sleeves 12 of the first type and the sleeve bodies 16 of the mounting sleeves 13 of the second type extend between the upper wall 10 and the lower wall 11 in the cavity portion 9 of the frame body 2 of the subframe 1. A mounting element, for example, a screw bolt, is able to be guided through the longitudinal passage 17 of the sleeve body 16, 17. The longitudinal passage 17 in the sleeve body 16 continues with the same diameter or with a graduated smaller diameter in the passage openings 20 of the sleeve heads 18, 19.

In at least one embodiment of the present disclosure, in the representations of FIG. 1 to FIG. 3 are able to be seen that the sleeve body 16 of a mounting sleeve 12 of the first type projects through the upper opening 14 in the wall 10 of the frame body 2, wherein the sleeve head 18 of the mounting sleeve 12 is arranged at a distance a from the opening 14 and from the adjacent outer surface 27 of the frame body 2. The mounting sleeve 12 therefore projects with an upper longitudinal portion 28 relative to the frame body 2 and its upper wall 10.

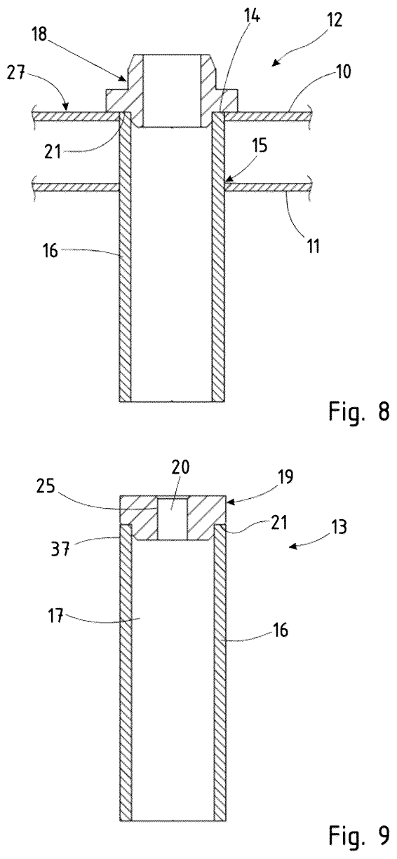

In the embodiment variant shown in FIG. 8, the mounting sleeve 12 of the first type rests with the disc element 22 on an upper wall 10 of the frame body 2. The sleeve body 16 is flush with the outer surface of the upper wall 10. The sleeve head 18 communicates with the opening 14 in the upper wall 10. The sleeve body 16 projects through an opening 15 in the lower wall 11 of the frame body 2. The mounting sleeve 12 of the first type is joined to the upper wall 10 and the lower wall 11.

FIG. 4, FIG. 5 and FIG. 10 illustrate that the sleeve head 19 of a mounting sleeve 13 of the second type is arranged in the opening 14 of the upper wall 10 of the frame body 2. The mounting sleeve 13 is joined to the frame body 2 in the region of the opening 14 and the sleeve head 19.

With a lower end 29 facing away from the sleeve head 18, 19, the sleeve body 16 contacts an inner surface 30 of the lower wall 11 of the frame body 2. The sleeve body 16 coaxially surrounds the lower opening 15 of the frame body 2. The sleeve body 16 rests with the end 29 on the inner surface 30 and is joined to the frame body 2.

In the subframe 1 shown in FIG. 10, the sleeve body 16 projects with a lower end portion 31 facing away from the sleeve head 19 through the opening 15 in the lower wall 11 of the frame body 2 and protrudes there opposite the lower wall 11 of the frame body 2. The sleeve body 16 is also joined to the frame body 2 in the region of the opening 15 in the lower wall 11.

In the region of the lower opening 15, the lower wall 11 of the frame body 2 has a pot-shaped indentation 32. The indentation 32 is formed inwardly into the cavity portion 9 of the frame body 2.

In FIG. 11A, FIG. 11B to FIG. 24A, Fig.24B, different embodiments of sleeve heads 18, 19 are shown, each in two perspective views. The sleeve heads 18, 19 are able to be heat treated or tempered and/or hardened.

FIG. 11A, FIG. 11B to FIG. 16A, FIG. 16B each show a sleeve head 18 with a disc element 22 and a front-side mounting portion 25. The mounting portion 25 is designed as a cylindrical fitting 33 projecting relative to the disc element 22.

The sleeve heads 18 in the embodiments according to the illustrations FIG. 13A, FIG. 13B to FIG. 16A, FIG. 16B have a positioning element 23 on the sleeve body side on the respectiveunderside 34 directed towards a sleeve body 16. The positioning element 23 is able to be designed as an extension 35, as shown in FIG. 13A, FIG. 13B and FIG. 14A, FIG. 14B. Furthermore, a further positioning element 23 is able to be formed by a ring 36 running concentrically around the extension 35 on the underside 34, as able to be seen in FIG. 15A, FIG. 15B and FIG. 16A, FIG. 16B. The positioning elements 23 or the extension 35 and the ring 36 protrude from the underside 34 of a sleeve head 18 or its disc element 22. The ring 36 includes a front end portion 37 (marked in FIG. 7 and FIG. 9) of the sleeve body 16 and rests against the end portion 37. The end portion 37 is received in the groove 38 between the extension 35 and the ring 36.

The sleeve heads 18 according to the embodiments of FIG. 12A, FIG. 12B, FIG. 14A, FIG. 14B, and FIG. 16A and FIG. 16B have a friction structure 39 on the respective front side 24. The friction structure 39 is formed by friction elements 40 which protrude at the upper side of the front side 24 of the sleeve head 18. The friction elements 40 are designed as ribs which extend radially outward around the mounting portion 25.

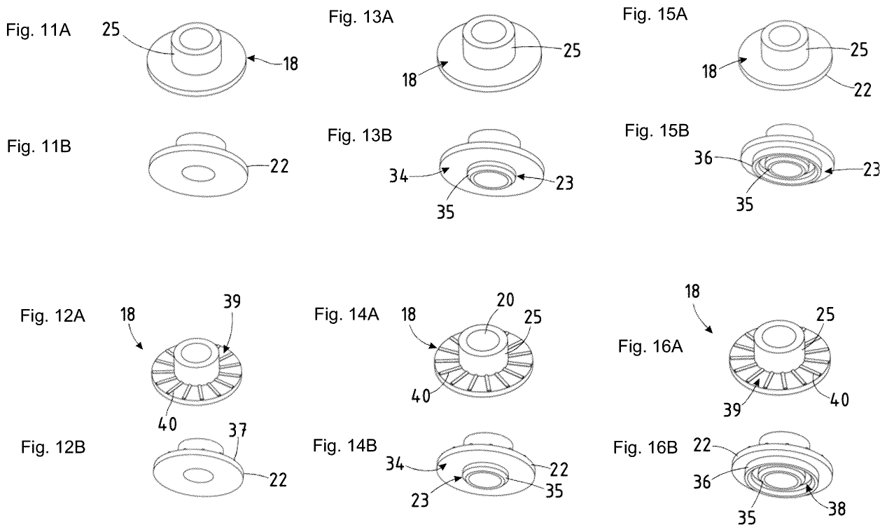

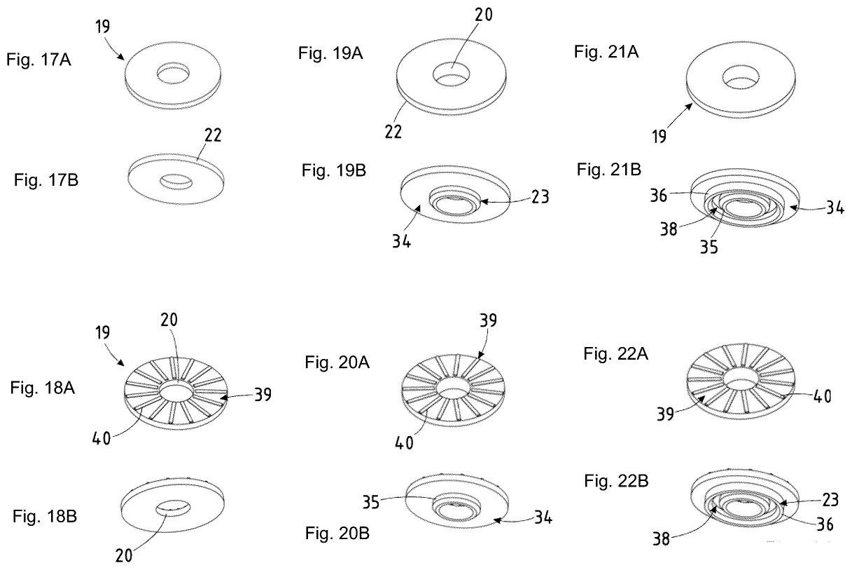

The illustrations in FIG. 17A, FIG. 17B to FIG. 22A, FIG. 22B show sleeve heads 19 with a disc element 22. Each sleeve head 19 has a passage opening 20. The designs of the sleeve heads 19 according to the illustrations in FIG. 19A, FIG. 19B to FIG. 22A, FIG. 22B have positioning elements 23 on the underside in the form of extensions 35 and rings 36. In this regard, reference is made to the above comments.

The embodiment of the sleeve heads 19 according to the representations of FIG. 18A, FIG. 18B, FIG. 20A, FIG. 20B, and FIG. 22A, FIG. 22B have on the respective front side 24 a friction structure 39 with friction elements 40 in the form of ribs which are arranged circumferentially around the passage opening 20 and extend radially outwards from the passage opening 20.

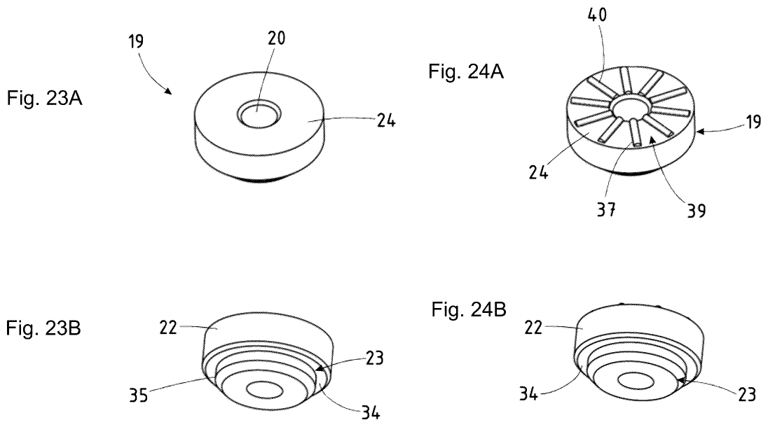

FIG. 23A, FIG. 23B and FIG. 24A, FIG. 24B again show a sleeve head 19 with a positioning element 23 in the form of an extension 35 on the underside 34 of the sleeve head 19. In the embodiment of the sleeve head 19 according to the illustration in FIG. 24A and FIG. 24B, a friction structure 39 is provided on the front side 24. The friction structure 39 is formed by friction elements 40 in the form of ribs which extend radially around the passage opening 20, are arranged offset on a pitch circle and extend outwards.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-16. (canceled)

17. A subframe for a motor vehicle, comprising:
a frame body and at least one mounting sleeve, wherein the mounting sleeve has a sleeve body with a longitudinal passage and a sleeve head with a passage opening, the sleeve head comprises a cold extruded part, wherein the passage opening is in the sleeve head, and the sleeve head and the sleeve body are separate components, and the sleeve head is on a front side on the sleeve body, wherein the sleeve body and the sleeve head are joined in a form-fitting or force-fitting manner.

18. The subframe according to claim 17, wherein the sleeve head has a disc element which rests on the sleeve body at the front side and at least one positioning element on a sleeve body side, which projects into the sleeve body or rests on an outside on a front end portion of the sleeve body.

19. The subframe according to claim 17, wherein the sleeve head has a mounting portion on a front side thereof facing away from the sleeve body.

20. The subframe according to claim 17, wherein the sleeve head has a friction structure.

21. The subframe according to claim 20, wherein the friction structure is provided on a front side of the sleeve head.

22. The subframe according to claim 20, wherein the friction structure at least partially surrounds the passage opening.

23. The subframe according to claim 20, wherein the friction structure comprises at least one friction element and the friction element is configured in a rib-shaped or point-shaped manner.

24. The subframe according to claim 17, wherein the frame body comprises shell components.

25. The subframe according to claim 17, wherein the sleeve head is in an opening of the frame body.

26. The subframe according to claim 17, wherein the sleeve head rests against the frame body with a contact surface on a sleeve body side.

27. The subframe according to claim 17, wherein the sleeve body projects through an opening in a wall of the frame body and the sleeve head is arranged at a distance from an outer surface of the frame body.

28. The subframe according to claim 17, wherein the sleeve body projects with an end portion facing away from the sleeve head through an opening in a wall of the frame body.

29. The subframe according to claim 17, wherein the sleeve body contacts an inner surface of a wall of the frame body with an end facing away from the sleeve head and surrounds an opening in the wall of the frame body.

30. The subframe according to claim 17, wherein the sleeve head has a threaded portion.

31. The subframe according to claim 17, wherein the sleeve head and the sleeve body comprise different materials.

32. The subframe according to claim 17, wherein the sleeve body or the sleeve head are hardened or tempered.
